(19) United States
(12) Patent Application Publication
(10) Pub. No.: US 2003/0047436 A1
(43) Pub. Date: Mar. 13, 2003

(54) Shooting and rearming mechanism for electrical devices and the like

(76) Inventors: Marti Palet Mercader, (US); Miguel Ortiz Gimenez, (US)

Correspondence Address: KLAUBER & JACKSON, 411 HACKENSACK AVENUE, HACKENSACK, NJ, 07601

(21) Appl. No.: 10/236,142

(22) Filed: Sep. 6, 2002

(30) Foreign Application Priority Data
Sep. 7, 2001 (ES) P200102023

(51) Int. Cl. H01H 13/14

(52) U.S. Cl. 200/520

(57) ABSTRACT

This mechanism is planned for tripping an electrical or mechanical apparatus or device, by means of which any type of actuating is performed, including the tripping and rearming means mechanism, the former being designed based on a swiveling lever (7) which is actuated by means of a hammer (6), causing the release of the locking of a trip (12) on a sliding part (16) moved toward the tripping position by means of a spring (25), whilst the rearming means are designed based on a pushbutton (26) to which a cam (29) which, when the pushbutton is pressed, pushes a skid (18) which slides along a ramp (17) of the slide (16), moving the slide along to cause the rearming by the interlocking thereon of a roller (15) pertaining to the trip (12). Said mechanism comprises a module which can be mounted on the device or apparatus on which the application thereof is feasible.

### BACKGROUND OF THE INVENTION

The present invention relates generally to mechanisms for tripping and rearming electrical mechanisms.

There are various ways in which the tripping of both electrical and mechanical apparatuses or devices can be performed in order to fulfill a specific function.

Specifically, in the field of electrical distribution circuit safeguarding, in which a differential relay and a circuit breaker connected to one another both electrically as well as mechanically are used, the circuit breaker must be tripped in order to carry out the intended protection in the presence of any change or imbalance in the electrical circuit or facility in which it is applied.

In this regard, there are systems in which the circuit breaker is tripped electrically, in other words, by means of a coil, which, being incorporated into and linked to the circuit breaker, provides the signal which makes the circuit breaker in question trip.

This electrical tripping system involves the drawback that, in the event of the improper installation or break in the conductor cable or any situation affecting said cable, over which the signal from the coil trips the circuit breaker, the circuit breaker might not be tripped, in addition to the trouble involved in performing all of the mounting operations.

To avoid this drawback, there are mechanical devices which are integrated into the differential module, comprising a more heavy-duty means which is more reliable with regard to assuring tripping.

However, the mechanisms which are currently being marketed integrated into the differential relays intended for use being connected to a circuit breaker to jointly form a protection system for electric distribution systems and/or equipment entail the drawback of their consisting of a very large number of parts.

A large number of parts obviously involves, first of all, a higher manufacturing cost and, therefore, a higher selling or marketing price for the product; and, secondly, a more highly involved mounting procedure of all of the parts to build the mechanism, with the added drawback of having a greater possibility of faults than if the mechanism were to have a smaller number of parts.

### SUMMARY OF THE INVENTION

The present invention, as is stated in the heading of this descriptive account, involves a tripping and rearming mechanism for apparatuses or devices which can be used in any field of application, although it is mainly designed for use in the electrical field, specifically for tripping electrical distribution circuit safeguard devices. This mechanism consists of a module comprised of a minimum number of parts which make it possible to trip and then subsequently rearm the apparatus or device to which it is applied after receiving a signal given out for any reason.

The object of this invention is that of providing a mechanism which can be used for tripping a device—following the actuating of a hammer element—which may be electrical (i.e. to interrupt a power supply) or which may be mechanical (i.e. to move a part, to perform an opening or closing procedure, etc).

The mechanism according to this invention is mainly designed specifically for its application in electrical distribution circuit safeguard devices, these devices being comprised by means of the combination of a differential line-to-ground fault protection relay and a circuit breaker, assembled and electrically wired to one another, the mechanism acting as a means of tripping the circuit breaker when an electrical signal given out as the result of an imbalance is detected by the differential relay. This mechanism includes means which act on the circuit breaker, causing the tripping thereof, as well as means for achieving the rearming of the mechanism proper subsequent to the completion of the tripping process, including means which prevent the circuit breaker from rearming prior to the rearming of the mechanism.

### DESCRIPTION OF THE INVENTION

The mechanism comprising the object of this invention, although being designed to trip any type of electrical and/or mechanical apparatus or device, as well as to perform the subsequent rearming of the apparatus or device proper, will be described herein based on its specific application in electrical apparatuses intended for use for the safeguard of electrical distribution circuits for the purpose of a better comprehension of its features.

In any event, this mechanisms comprises a module which can be mounted on the device or apparatus to be tripped, and in this regard is designed to perform the tripping based on the actuation of a hammer which is what acts on the mechanism to perform the tripping of the apparatus in question, subsequently making it possible for the rearming of the mechanism proper to be performed.

This mechanism, when applied to an electrical protection apparatus comprised, for example, of a differential relay and a circuit breaker, will be mounted on the differential relay, the mechanism including a hammer element based on which the means in charge of performing the tripping of the corresponding apparatus are actuated, in this case, of the circuit breaker linked to the differential relay into which the mechanism proper is integrated.

Said hammer can be comprised of a pivot which can be actuated by means of a relay which receives the electrical signal given out, for example, due to a disturbance in the case that the mechanism is applied to the aforementioned type of apparatuses, in other words, to that comprised of a differential relay and a circuit breaker as electrical distribution circuit safeguard apparatuses, all this being such that, as of the actuation of the aforementioned relay, the different parts comprising the mechanism are set into motion up to the point of tripping the circuit breaker connected to the differential into which the mechanism proper is integrated.

This mechanism basically consists of a lever with one of its ends facing the hammer element, which may correspond to a pivot emerging from the relay, while the opposite end of said lever has a swivel-mounted hub, from which the lever extends into a first arm, the free end of which is then facing the back of a slide part, referred to hereinafter as the main slide, which is permanently held in the tripping position by means of a powerful spring, said slide being interlockable into the rearming position against the force of said spring which is, in short, what causes the tripping, the interlocking of said main slide being made by the end of a swivel trip connected to a spring which makes this trip slant constantly toward the interlocking position. This trip swivels on a supporting point or vertex and has a roller on its interlocking end which is properly greased to achieve minimal friction or rubbing and to allow for a fast escapement or release from the main slide during the tripping operation.

The interlocking and corresponding rearming of the mechanism is achieved by means of a pushbutton which, when pressed, causes, by means of a cam to which it is connected, the pushing of a skid which rests on a ramp formed on the main slide, such that the axial movement of said skid, when the pushbutton is pressed and the cam connected to it moves, causes the main slide to be pushed forward, in other words, toward the rearming position, against the spring which tends to push it toward the tripping position. In this movement, the interlocking of roller provided on the end of the trip takes place, this trip, as has been previously mentioned, is constantly pushed toward said position by means of a spring. The roller of said trip is then interlocked on a step of the main slide, holding the slide in its rearmed position ready for the tripping to be performed.

The section of the trip which lies between the swivel point and the end on which the interlocking roller is located must be situated at a minimum angle in order, on one hand, to keep the interlocking position stable and to withstand the thrust to which it is subjected by the force of the spring which pushes the main slide and, on the other, to allow for a quick release at the moment minimal force is exerted on it by the lever which can be actuated by the hammer element.

The lever which can be actuated by the hammer element or pivot of the relay, in addition to the first arm with its free end facing the back end of the main slide, has a second arm which also extends out from its swivel hub, the second arm of which extends downward on a slant, comprising a support for the trip. A regulator set-screw can act on this second arm to provide greater accuracy in the tripping which is done on the trip.

Going back to the pushbutton and to the cam which is connected to it to achieve the interlock, both of these parts are independent from one another but are related to each other by means of an axis of swivel of the cam as related to the pushbutton proper, allowing the cam to be able to swivel up against an elastic element to recover its normal position, such that the swiveling provides a freedom of movement for the main slide towards its tripping position, in other words, it allows the aforementioned main slide to move all the way back even when the pushbutton is held down.

The repeatedly aforementioned main slide has a second slide part attached, which shall be referred to hereafter as the secondary slide, which, during the movement of the main slide toward the rearming position, does not move along with the main slide while the pushbutton is held down, given that it is prevented from doing so by the skid against which a fin of said secondary slide butts. However, when the pushbutton is released, this secondary slide and the skid move in the same direction in which the main slide had moved by means of a spring located between the two.

Given that this secondary slide is that which acts in the tripping of the mechanism on the corresponding means provided in the circuit breakers to cause the circuit breaker to trip, if said secondary slide remains in that tripping position while the main slide moves toward the rearming position, it would not be possible to rearm the circuit breaker, as a result of which said secondary slide serves as a safeguard to prevent the circuit breaker from rearming without previously having rearmed the mechanism, given that the rearming of said circuit breaker prior to the rearming of the mechanism could cause irreparable damage to both the equipment or circuits to be safeguarded as well as personal injuries.

This secondary slide remains moved back during the pressing of the pushbutton, as a result of which, when the pushbutton is pressed, the end of the cam connected to the pushbutton pushes and moves the skid, which slides along the ramp of the main slide. This sliding downward of the skid, which entails the moving of the main slide to the rearming position, is a stumbling block for the secondary slide, preventing it from moving in the direction of the main slide. However, when the pushbutton is released, it returns to its position by itself, taking the cam connected to it along with it, causing the skid to be released and then making it possible for the secondary slide to move by means of the spring located between the secondary and main slides. In this movement, said secondary slide pushes the skid along with it toward the position where it was located when the pushbutton was pressed.

Apart from the above, means have been provided for retaining the hammer, or what is the same, of achieving the automatic closing of the relay following the completion of the tripping procedure, allowing for the rearming of the mechanism, given that were the relay not to close, its pivot would be pushing on the lever, and the lever would be pushing on the trip, preventing the interlocking roller from positioning itself on the step of the main slide.

The means for the automatic closing of the relay are based on the fact that the back of the main slide, when the mechanism is tripped and, therefore, the backward movement of said main slide, butts up against the end of the first arm which extends out from the lever facing the hammer or pivot of the relay, so that this impact makes the lever swivel in the opposite direction, exerting a thrust on the hammer or pivot of the relay and, therefore, the retracting of the hammer, causing the retracting of the same or automatic closing of the aforementioned relay.

The impact of the back part of the main slide on the arm of the lever takes place by means of an elastic shock-absorbing element comprised of a spring located on the inside of a properly-positioned fork and in a slot on the back part of the main slide. Said spring will prevent the relay from being damaged during the rearming of the mechanism, in other words, during the automatic closing of the relay proper, as a result of the blow or impact on the hammer being cushioned.

Apart from this, special mention may be made as to the fact that the aforementioned main slide is guided, in its mounting and movement, by means of two pairs of guide pins provided on both sides, these guide pins moving in windows or guides provided for this purposes on the shell.

Apart from that, when the mechanism relies on the relay for the actuating process, said relay would take the form of a very low-consumption, miniature relay and, therefore heating up to a minimal degree, having a screening or armoring system to prevent the whatever magnetic fields which might be created by short-circuits or other changes from causing damage and/or changes in the features of the respective magnet of the relay, which would cause the relay to fail.

Likewise, this relay has been designed to be mounted suspended by means of two supports, each one of which is comprised of a piece of elastic materials (rubber or similar) which is suitably tied to prongs extending out from the relay, these parts being supported, by means of four rounded ribs, on the shell corresponding to the mechanism, this mounting forming a fully suspended positioning for the relay and, therefore, confining the transmission of vibrations caused by blows or due to any other reason inherent to the relay proper to a minimum.

As far as the coupling and closing together of the two halves of which the shell of the mechanism is comprised is concerned, this is achieved by means of two cylindrical studs in the form of long, thin pivots which are made in the process proper of the conforming of one of the two halves, which, in the assembling with the other half, are facing openings provided in the other half such that a blow or downward thrust on these pivots in said openings causes the two halves to be securely fastened to one another.

### BRIEF DESCRIPTION OF THE DRAWINGS

To supplement the description which will be provided in following and for the purposes of aiding in a better comprehension of the features of this invention, a set of drawings is attached to this descriptive account, based upon which the innovations and advantages of the tripping and rearming mechanism embodied as per the object of the invention may be more readily understood.

FIG. 1. Showing a perspective overview of the mechanism of the invention.

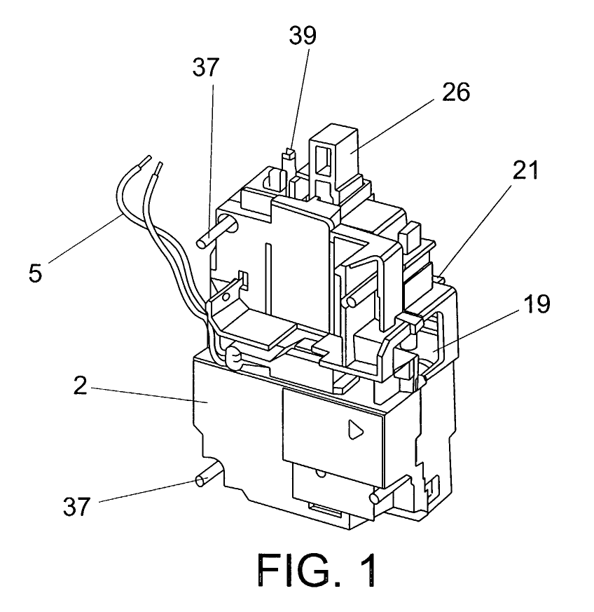

FIG. 2. Showing an enlarged dismantled view of the mechanism shown in the immediately preceding figure hereinabove, allowing the different parts of which it is comprised to be shown.

FIG. 3. Showing a front view of the mechanism shown in FIG. 1.

FIG. 4. Showing a front view of the mechanism with its corresponding cover or half-shell removed in the initial processing of the rearming of the mechanism.

FIG. 5. Showing the same view as in the immediately preceding figure hereinabove, with the mechanism in rearmed status.

FIG. 6. Showing the same view as in the immediately preceding figures hereinabove, with the mechanism in the initial tripping process.

FIG. 7. Showing another view of the mechanism the same as in FIGS. 4, 5 and 6, but in this case, with the mechanism tripped.

### DESCRIPTION OF AN EMBODIMENT OF THE INVENTION

In view of the aforementioned figures, it can be seen how the mechanism of the invention forms a module which is comprised of two half-shells 1 and 2 which are joined together, as will be explained at a further point herein, forming a box which houses inside the different parts comprising the mechanism or module, which is designed for problem-free mounting on whatever apparatus or device to which it is applied.

First of all, the mechanism will be described based on an embodiment in which the hammer element which is embodied from a relay 3 duly positioned between the two shells 1 and 2 and supplemented with a metal armoring or screening 4 which prevents the relay from sustaining the effects of whatever magnetic field might be created by short-circuits or other means. By way of the conductors 5, the relay 3 receives the signal resulting from a detection of changes of any type for the purpose of the actuation of said relay 3, which involves the tripping of a pivot 6 of said relay, sets the different parts of the mechanism into movement up to the point of achieving the tripping of the corresponding mechanism, which, in the case of the specific aforementioned application, corresponds to a circuit breaker electrically connected and attached to a differential relay into which the mechanism proper is integrated.

The main parts of the mechanism include a lever 7 with one of its ends facing the pivot 6 of the relay 3, while said lever 7 extend out from a bracing up to a hub 8 comprising the pivoting or swiveling mounting means for said lever 7, which, in turn, extends out from this swiveling hub 8, in an arm 9, while, in turn, a short arm 10 slants downward, the end of which is screwed down by regulator set-screw 11 mounted on a trip 12 pushed by a spring 13, the trip 12 of which has a swivel point 14, from which a section 12′ extends with its free end fitted with a roller 15, the function of which will be explained at a further point herein. The regulator set-screw 11 is optional, given that its function is that of providing greater accuracy for the tripping process.

In addition to the above, the mechanism also includes, as main elements or parts, a slide 16 duly guided on the inside of the box formed by the half-shells 1 and 2, the slide 16 of which has a slot inside with a ramp 17, in which a slide 18 can slide, whilst also mounted on said slide 16 is a another slide, the secondary slide 19, between which and the main slide 16, a spring 20 has been provided so that the relay 3 will be prevented from being damaged during the rearming process, given that said spring 20 serves as a shock-absorbed to lessen the impact on the pivot 6 of the relay 3. The secondary slide 19 has a side branch 21 emerging to the outside of the mechanism, specifically through a window provided for this purpose in the semi-shell 1, serving as an actuator on the device or apparatus to be tripped, which will be achieved by means of intermediate elements.

Likewise, on the main slide 16, specifically in a slot on its back part, a fork 22 is mounted which retains a spring 23 located between this fork 22 and the back of the slot provided for this purpose in the main slide 16, being fork 22 being mounted to be able to move and serving a purpose which shall also been explained at a further point herein.

Between the side 24 of the semi-shell 1 and the main slide 16, a strong spring 25 is installed which tends to constantly push the aforementioned main slide 16 toward the opposite side of said side 24, considered as the back of the mechanism.

Also included is a pushbutton 26 for the manual actuation of the rearming process, which runs out from the top part of the box formed by the half-shells 1 and 2, being moved toward the emergency position by means of a spring 27. Connected to said pushbutton 26, by means of a swivel shaft 28, is a lever 29 which moves jointly with the pushbutton 26, the cam of which has a heel 30 underneath and an elastic side branch 30′ based on which said cam 29 can swivel and allow the main slide 16 full run when the main slide 16 is released, as will be explained at a further point herein.

The mechanism is completed with a part 31 located at the back, with one emerging end 32 which comprises a manual trip element, the part 31 of which is moved toward a home position by a spring or coil 33, part 31 also having a side branch 34 through which the mechanism is precisely tripped when the part 31 proper in pressed downward against the action of the spring 27.

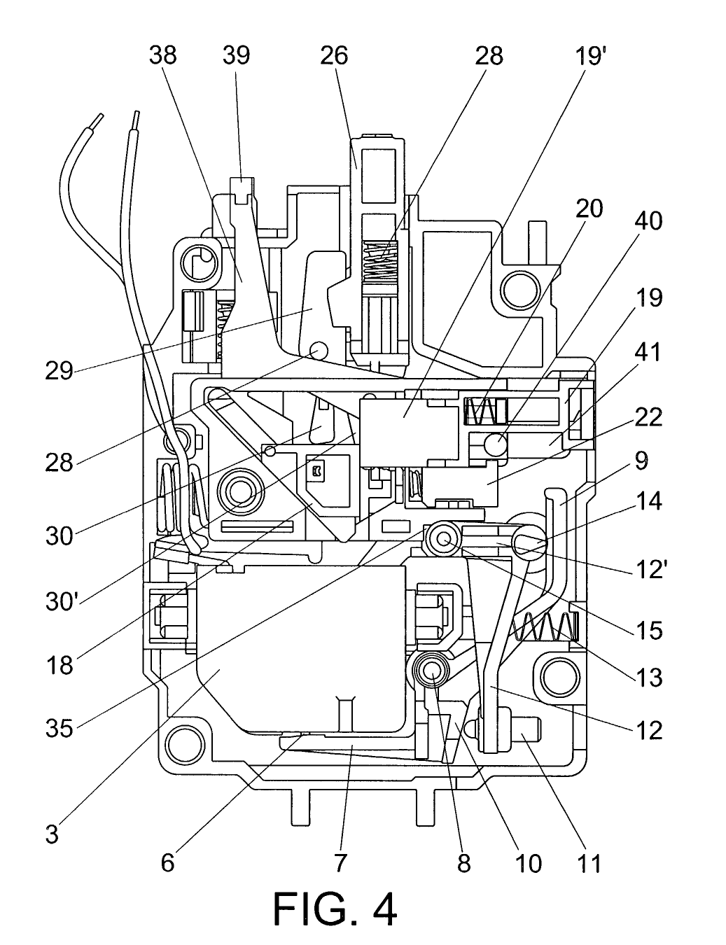

Based on the aforementioned features and with regard to FIGS. 4, 5, 6 and 7, the functioning or phases of the rearming and tripping of the mechanism are as follows:

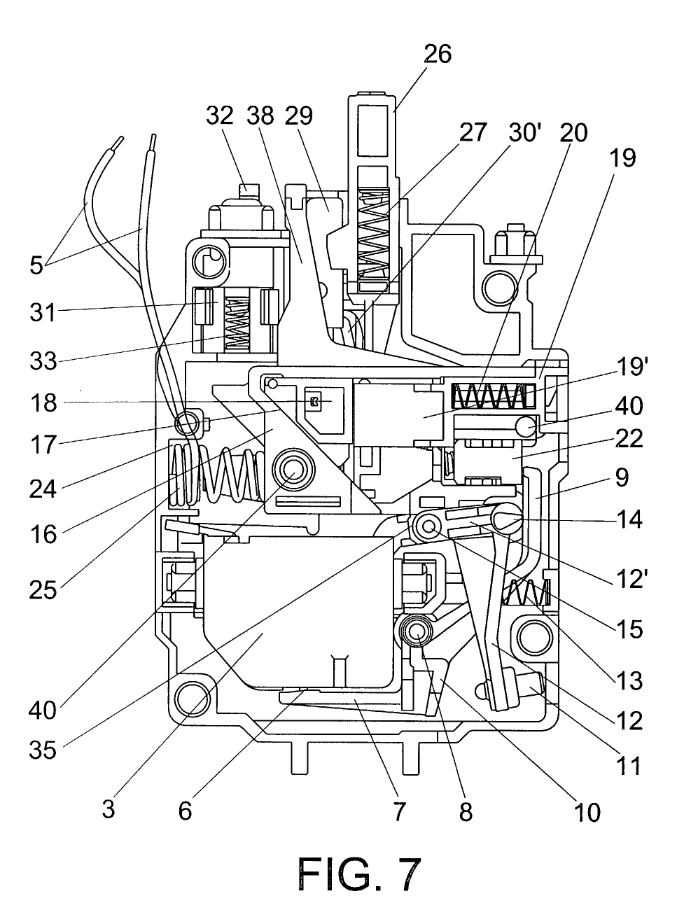

Starting from the position shown in FIG. 7, in which the mechanism is shown in the tripped position, if the pushbutton 26 is pressed, the movement of the pushbutton involves the movement of the cam 29, such that the heel 30 of the cam presses on the skid 18, which will slide along the ramp 17 of the main slide 16, logically causing the main slide 16 to move backward against the action of the spring 25, exactly as shown in FIG. 4. Although the secondary slide 19 is mounted on the main slide 16, said secondary slide 19 remains still, as a result of which a fin 19′ of the secondary slide 19 butts up against the skid 18 in the downward movement caused by the skid 18, precisely preventing said secondary slide 19 from moving backward while the pushbutton 26 is held down, which will logically keep the skid 18 in a downward-moving position.

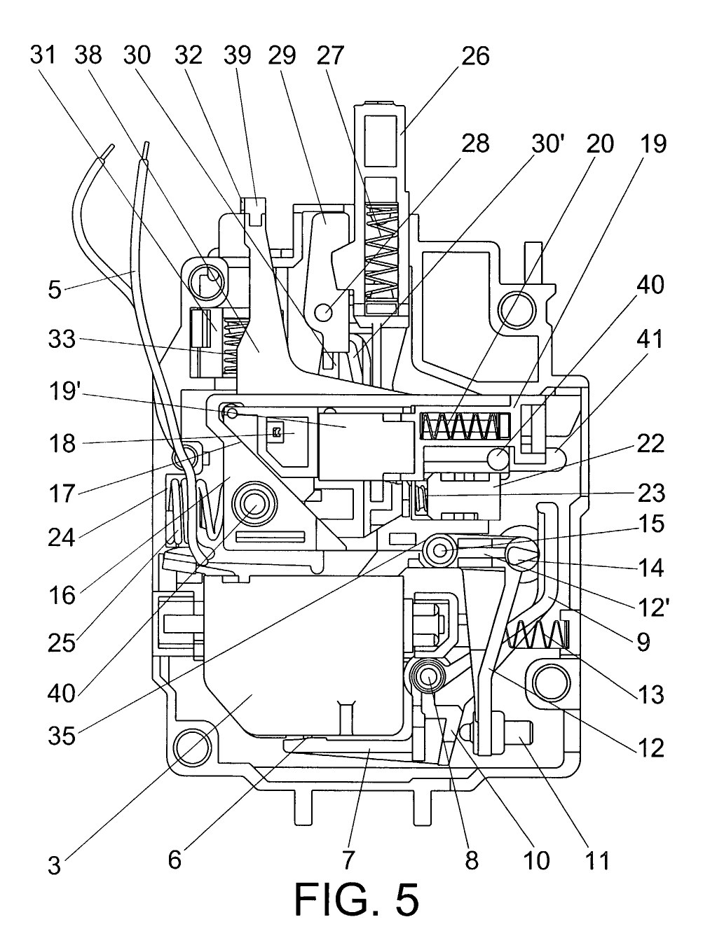

However, at the moment when the pushbutton 26 is released from pressing, as is shown in FIG. 5, the heel 30 of the cam 29 connected to said pushbutton 26 stops pressing on the skid 18, as a result of which the skid 18 is pushed by the fin 19′ of the secondary slide 19, sliding upward exactly as shown in FIG. 5 proper, this being a movement which is made as a result of the spring 20 located between the main slide 16 and the secondary slide 19.

The mechanism is therefore rearmed and ready to be tripped, so that if said tripping is done manually, the upper end 32 of the part 31 will be pressed down, making the side branch 34 of that part 31 move a branch 15′ of the trip 12, releasing the lock caused, which causes the tripping.

In the rearming process, the slide part 16 must obviously be kept in the position shown in FIG. 5, the locking being achieved by means of the cylinder 15 provided on the section 12′ of the trip 12, which is precisely moved by the spring 13 toward that locking position, in other words, swiveling tending toward the roller 15 positioning itself on the back step 35 provided for this purpose on the lower part of the main slide 16.

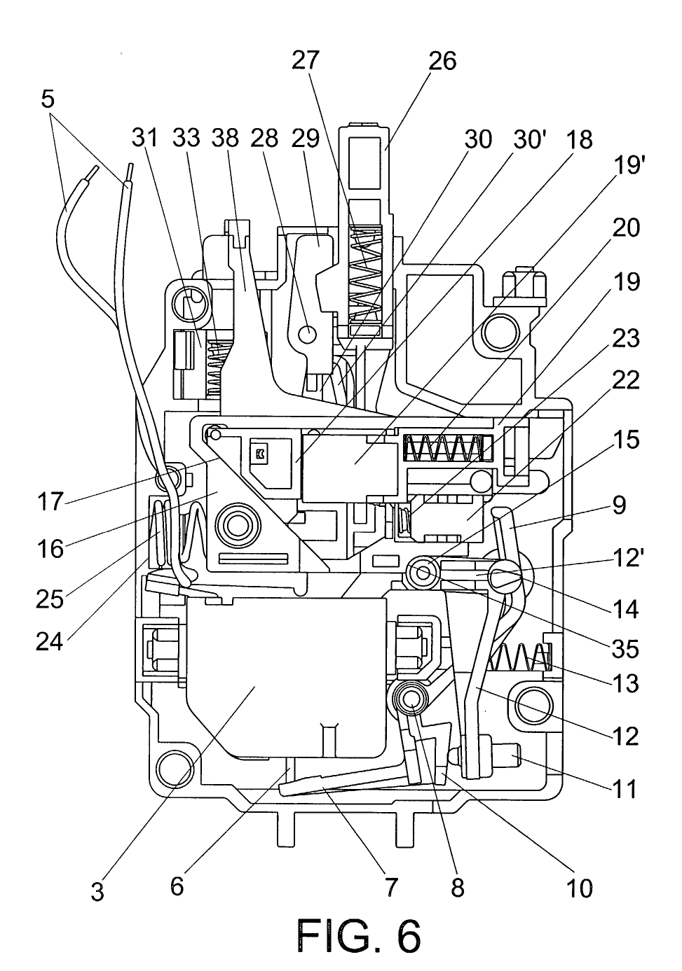

From the rearming position corresponding to FIG. 5, the tripping process is performed according to what is shown in FIGS. 6 and 7.

In this regard, when in the position shown in FIG. 5, the relay 3 receives the corresponding electrical signal caused by the detection of a fault or imbalance, the actuation of said relay 3 is causes and, therefore, the tripping of its pivot 6, which acts on the end of the lever 7, causing the lever 7 to swivel around point 8, this swiveling making the lower slanted arm 10 act on the regulator set-screw 11 of the trip 12, making the trip 12 swivel around its point of support 14, causing the unlocking of the roller 15 from the step 35 of the main slide 16.

At the same time as the triggering is taking place, in order to allow the mechanism to rearm once again, it is necessary for the pivot 6 of the relay 3 to retract, given that, otherwise, the lever 7 would be pushed by said pivot 6 and thus constantly pushing on trip 12 which would keep it in inoperative or unlocked position with regard to the main slide 16.

However, in order to prevent such a situation, a system for the automatic closing of relay 3 has been provided, or what is the same, for the retracting of the pivot 6 of relay 3, based on the fact that in the tripping or backward movement of the main slide 16, said main slide 16 hits up against the end of the arm 9 corresponding to the lever 7, making the lever 7 swivel and therefore pushing the pivot 6 in its retracting direction, thus achieving the automatic closing of the relay 3.

The main slide 16 must hit the end of the arm 9 gently or in a cushioned manner, for which purpose it has been provided that this impact fall on a shock-absorber element comprised of the fork 22, which is capable of moving forward and backward and which is moved toward a backward movement position by means of the spring 23, so that when the end of the arm 9 hits on the back end of the fork 22, the fork 22 moves against the action of the spring 23, causing the pretended cushioning, all of which is in order to prevent the relay 3 from directly sustaining the blow caused by the force of the powerful spring 25 for the purpose of prolonging the useful life of the relay 3.

In addition to the main basic features described for this mechanism, the mechanism in question includes other noteworthy details, some of those of which special mention may be made being:

The roller 15 for locking the trip 12 will be suitably lubricated in order to minimize the rubbing and achieve an efficient release from the step 35 of the main slide 16.

Likewise, it has been provided that the trip 12 proper, instead of swiveling on a shaft or any other appropriate means, will swivel on a point 14, considered as a “knife”, which minimizes the friction and perfectly determines the executing of the tripping process, given that, based on said special support and swiveling pint, at the moment when any force is received, it immediately swivels and the aforementioned release or unlocking of the main slide 16 is achieved, with the unique aspect, in order to prevent the presence of any vibration from being able to carry out the unlocking and, therefore, the tripping process, it has been provided that the section 12′ of the trip 12 be angled slightly above the horizontal in order to accurately maintain the stable position in a locking situation, given that it must be withstanding the force of the spring 25, which is remarkable.

Likewise, is has been provided that the relay 3 have the screening or armoring 4 in order to prevent the magnetic fields created by possible short-circuits or other faults from possibly affecting the magnet of the relay proper, which would entail the failure of the relay.

Likewise, It has been provided that the cam 29 connected to the pushbutton 26, in addition to the heel 30 which presses on the skid 18 have an elastic side branch 30′ which serves as a spring in order to allow the swiveling and recovery of said cam 29 as related to the mounting axis 28 related to the pushbutton 26 and to allow, by way of this swiveling, that the main slide 16 make its full run, given that, otherwise, that is to say, if the cam 29 were not to swivel, said slide 16 would be prevented from making the full run while the pushbutton 26 is held down.

Also worthy of special mention is the fact that both the relay 3 as well as the mechanism assembly as a whole, or what is the same, the box comprised of the half-shells 1 and 2, are mounted, in the first case, in relation to said box comprised of half-shells 1 and 2 and, in the second case, by mounting the box on the overall structure of the differential by means of some supports comprised of some pieces of elastic material 36, making the mounting of this differential be floating as a result of said relay 3 being supported solely by means of the two pieces 36, these parts resting on the corresponding half-shells 1 and 2 by means of rounded ribs provided on the corners or edges of the pieces 36 proper, as a result of which the support is precise, making the relay 3 being kept practically floating in order to prevent the vibrations or blows from reaching the relay 3 proper, the same also being the case for the mounting of the box comprised of half-shells 1 and 2.

The half-shells 1 and 2 are joined to one another by means of very thin cylindrical studs 37, which are made in the process proper of conforming one of the half-shells 2, so that in the process of attaching the half-shells 1 and 2 to each other, by pressing on these cylindrical studs 37, said cylindrical studs fit into openings provided for this purpose in the other half-shell, making it possible to secure these two half-shells 1 and 2 to one another by the fasteners which comprised the aforementioned cylindrical studs 37.

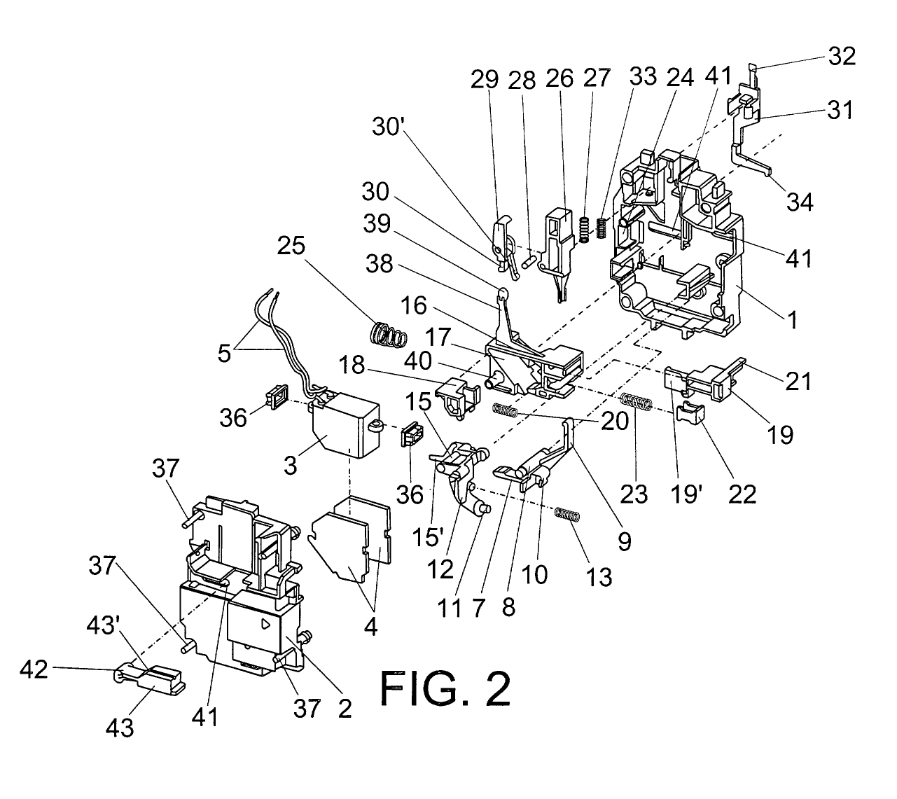

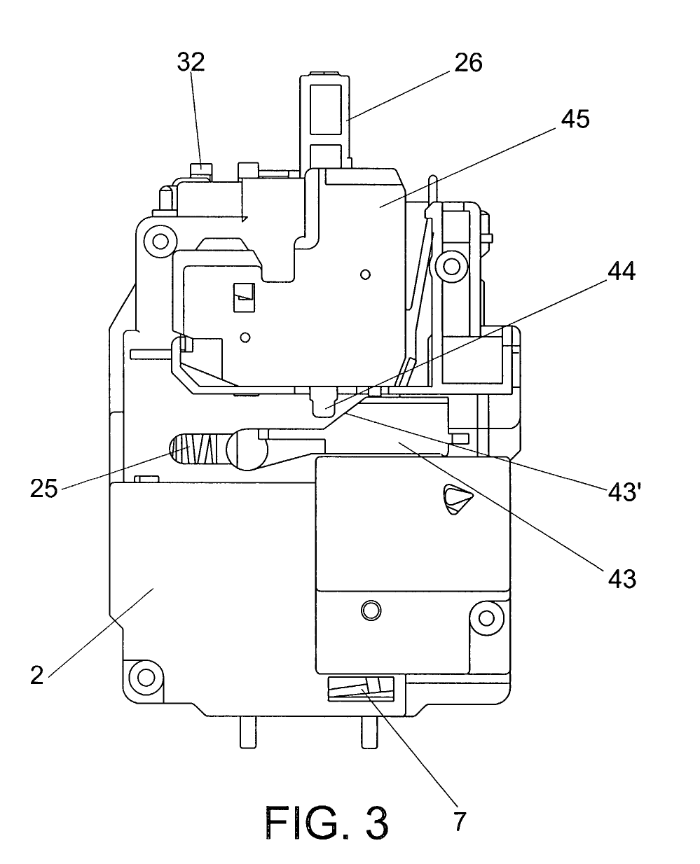

Lastly, it must be said that the main slide 16 has a stud 38 which emerges to the exterior, the outside end 39 of which forms an indicator corresponding to the “rearmed” and “tripped” positions, logically according to the position of the main slide 16, the movements of which are made in a guided manner by way of stubs 40 which slide in widows 41 provided for this purpose on the half-shells 1 and 2; it having been provided that the stub 40 which can be seen in FIG. 2 protrude through the window 41 of the half-shell 2 and be positioned in a seat or aperture 42 of a piece 43 which is moved along with the slide 16, piece 43 which will act, by way of its ramp 43′ on a stud 44 pertaining to a movable contact-holder slide connected to a block of contacts 45, as is shown in FIG. 3. Said piece 43 is shown in FIG. 2.

1. SHOOTING AND REARMING MECHANISM FOR ELECTRICAL DEVICES AND THE LIKE, applicable in electrical distribution circuit safeguard devices, preferably in those comprising a current leak to chassis-ground protection differential relay connected electrically and mechanically to a switch to be tripped, being likewise applicable to other electrical and/or mechanical devices, in order to perform the tripping of one thereof and to carry out any type of actuation, the mechanism being provided with means which enable a manual rearm, even provided with a manual tripping element; wherein it is modular set which comprises a lever facing at one of its ends a hammer; said lever extending, behind a swivel hub or center, into an arm pointing upward and into another arm short in length and pointing downward, in order to support a trip mounted to swivel on a point of support, whose trip is provided with a branch ending in a roller, determining an interlocking element for a main slide which slides forward and backward, being moved toward a permanent trip position by means of a powerful spring as an element causing the trip, said spring being mounted between the front end of said main slide and the side corresponding to the shell of the mechanism; said main slide being provided with a ramp on which a skid slides which is actuated to be pushed by means of a heel belonging to a corresponding cam, by means of a swiveling point, with a manually-actuated pushbutton constantly projecting outward by means of a spring.

2. SHOOTING AND REARMING MECHANISM FOR ELECTRICAL DEVICES AND THE LIKE, according to claim 1, wherein on the main slide, there is a secondary slide mounted with a spring interposed in between both of them, forming an element for cushioning the impact on the hammer during the rearming process, said secondary slide being provided with a side branch which emerges to the outside forming the element for actuating the switch for the tripping thereof, when the tripping of the mechanism takes place with the respective backward movement of the main slide and of the secondary slide together thereof.

3. SHOOTING AND REARMING MECHANISM FOR ELECTRICAL DEVICES AND THE LIKE, according to claim 1, wherein in the downward movement of the pushbutton and, therefore, of the cam associated thereto, in the tripping position of the mechanism, the skid is moved downward by a push of the heel belonging to the cam, the forward movement of the main slide being caused by the sliding of said skid on the ramp intended for this purpose on said main slide, said movement being made against the action of the spring, provision having been made that in said movement during the pulsation of the pushbutton, the secondary cam remaining still by means of a fin of said secondary cam abutting against the skid, whilst the release of the pushbutton and its corresponding upward movement causes release of the skid and, as a result thereof, the pushing and movement of the skid and of the secondary slide which is impelled by the spring located between said secondary slide and the main slide.

4. SHOOTING AND REARMING MECHANISM FOR ELECTRICAL DEVICES AND THE LIKE, according to claim 1, wherein the trip is constantly moved toward a locking position, by means of its end roller on a step provided in the lower and back part of the main slide, due to the pushing of a spring, causing the unlocking and, therefore, the tripping of the mechanism when the corresponding hammer emerges to the outside, causing the pushing and corresponding swiveling of the lever, whose arm acts on the end of the trip, making said trip swivel by means of the swiveling point, releasing the roller with respect to the locking step of the main slide.

5. SHOOTING AND REARMING MECHANISM FOR ELECTRICAL DEVICES AND THE LIKE, according to claim 1, wherein the arm into which the lever extends, faces at its free end a cushioning element comprising a fork which is movable forward and backward and is constantly moved toward the back position by means of a spring, so that, during the tripping and corresponding backward movement of the main slide, the impact of said cushioning element comprising the fork and the spring on the arm takes place, making the arm swivel so that the lever of which it is part of, will swivel and push the hammer toward the inside.

6. SHOOTING AND REARMING MECHANISM FOR ELECTRICAL DEVICES AND THE LIKE, according to claim 2, wherein the arm into which the lever extends, faces at its free end a cushioning element comprising a fork which is movable forward and backward and is constantly moved toward the back position by means of a spring, so that, during the tripping and corresponding backward movement of the main slide, the impact of said cushioning element comprising the fork and the spring on the arm takes place, making the arm swivel so that the lever of which it is part of, will swivel and push the hammer toward the inside.

7. SHOOTING AND REARMING MECHANISM FOR ELECTRICAL DEVICES AND THE LIKE, according to claim 1, wherein the main slide, in its forward and backward movements, is guided by means of pivots, which slide in windows provided for this purpose in the corresponding half-shells which comprise the box in which the different parts comprising the mechanism are located.

8. SHOOTING AND REARMING MECHANISM FOR ELECTRICAL DEVICES AND THE LIKE, according to claim 2, wherein the main slide, in its forward and backward movements, is guided by means of pivots, which slide in windows provided for this purpose in the corresponding half-shells which comprise the box in which the different parts comprising the mechanism are located.

9. SHOOTING AND REARMING MECHANISM FOR ELECTRICAL DEVICES AND THE LIKE, according to claim 5, wherein the main slide, in its forward and backward movements, is guided by means of pivots, which slide in windows provided for this purpose in the corresponding half-shells which comprise the box in which the different parts comprising the mechanism are located.

10. SHOOTING AND REARMING MECHANISM FOR ELECTRICAL DEVICES AND THE LIKE, according to claim 6, wherein the main slide, in its forward and backward movements, is guided by means of pivots, which slide in windows provided for this purpose in the corresponding half-shells which comprise the box in which the different parts comprising the mechanism are located.

11. SHOOTING AND REARMING MECHANISM FOR ELECTRICAL DEVICES AND THE LIKE, according to claim 1, wherein the hammer comprises of a pivot which emerges from a very low-consumption and minimum-heating relay as the element receiving the corresponding signal for actuating the own mechanism; said relay being mounted in a floating manner by means of a pair of elastic pieces of an overall prismatic configuration, whose edges form rounded ribs forming the supports thereof on the corresponding shell, determining a floating mounting means for the own relay, increasing the resistance to vibrations transmitted to said relay.

12. SHOOTING AND REARMING MECHANISM FOR ELECTRICAL DEVICES AND THE LIKE, according to claim 2, wherein the hammer comprises of a pivot which emerges from a very low-consumption and minimum-heating relay as the element receiving the corresponding signal for actuating the own mechanism; said relay being mounted in a floating manner by means of a pair of elastic pieces of an overall prismatic configuration, whose edges form rounded ribs forming the supports thereof on the corresponding shell, determining a floating mounting means for the own relay, increasing the resistance to vibrations transmitted to said relay.

13. SHOOTING AND REARMING MECHANISM FOR ELECTRICAL DEVICES AND THE LIKE, according to claim 1, wherein one of the pivots of the main slide emerges to the outside of the corresponding half-shell, being lodged in an opening provided for this purpose in a piece which is moved with the main slide, whose piece is provided with a ramp able to act, in said movement, on a projection belonging to a movable contact-holder slide mounted on a block of contacts associated to the own mechanism.

14. SHOOTING AND REARMING MECHANISM FOR ELECTRICAL DEVICES AND THE LIKE, according to claim 2, wherein one of the pivots of the main slide emerges to the outside of the corresponding half-shell, being lodged in an opening provided for this purpose in a piece which is moved with the main slide, whose piece is provided with a ramp able to act, in said movement, on a projection belonging to a movable contact-holder slide mounted on a block of contacts associated to the own mechanism.

15. SHOOTING AND REARMING MECHANISM FOR ELECTRICAL DEVICES AND THE LIKE, according to claim 5, wherein one of the pivots of the main slide emerges to the outside of the corresponding half-shell, being lodged in an opening provided for this purpose in a piece which is moved with the main slide, whose piece is provided with a ramp able to act, in said movement, on a projection belonging to a movable contact-holder slide mounted on a block of contacts associated to the own mechanism.

16. SHOOTING AND REARMING MECHANISM FOR ELECTRICAL DEVICES AND THE LIKE, according to claim 6, wherein one of the pivots of the main slide emerges to the outside of the corresponding half-shell, being lodged in an opening provided for this purpose in a piece which is moved with the main slide, whose piece is provided with a ramp able to act, in said movement, on a projection belonging to a movable contact-holder slide mounted on a block of contacts associated to the own mechanism.

17. SHOOTING AND REARMING MECHANISM FOR ELECTRICAL DEVICES AND THE LIKE, according to claim 7, wherein one of the pivots of the main slide emerges to the outside of the corresponding half-shell, being lodged in an opening provided for this purpose in a piece which is moved with the main slide, whose piece is provided with a ramp able to act, in said movement, on a projection belonging to a movable contact-holder slide mounted on a block of contacts associated to the own mechanism.

18. SHOOTING AND REARMING MECHANISM FOR ELECTRICAL DEVICES AND THE LIKE, according to claim 8, wherein one of the pivots of the main slide emerges to the outside of the corresponding half-shell, being lodged in an opening provided for this purpose in a piece which is moved with the main slide, whose piece is provided with a ramp able to act, in said movement, on a projection belonging to a movable contact-holder slide mounted on a block of contacts associated to the own mechanism.

19. SHOOTING AND REARMING MECHANISM FOR ELECTRICAL DEVICES AND THE LIKE, according to claim 9, wherein one of the pivots of the main slide emerges to the outside of the corresponding half-shell, being lodged in an opening provided for this purpose in a piece which is moved with the main slide, whose piece is provided with a ramp able to act, in said movement, on a projection belonging to a movable contact-holder slide mounted on a block of contacts associated to the own mechanism.

20. SHOOTING AND REARMING MECHANISM FOR ELECTRICAL DEVICES AND THE LIKE, according to claim 10, wherein one of the pivots of the main slide emerges to the outside of the corresponding half-shell, being lodged in an opening provided for this purpose in a piece which is moved with the main slide, whose piece is provided with a ramp able to act, in said movement, on a projection belonging to a movable contact-holder slide mounted on a block of contacts associated to the own mechanism.

21. SHOOTING AND REARMING MECHANISM FOR ELECTRICAL DEVICES AND THE LIKE, according to claim 11, wherein one of the pivots of the main slide emerges to the outside of the corresponding half-shell, being lodged in an opening provided for this purpose in a piece which is moved with the main slide, whose piece is provided with a ramp able to act, in said movement, on a projection belonging to a movable contact-holder slide mounted on a block of contacts associated to the own mechanism.

22. SHOOTING AND REARMING MECHANISM FOR ELECTRICAL DEVICES AND THE LIKE, according to claim 12, wherein one of the pivots of the main slide emerges to the outside of the corresponding half-shell, being lodged in an opening provided for this purpose in a piece which is moved with the main slide, whose piece is provided with a ramp able to act, in said movement, on a projection belonging to a movable contact-holder slide mounted on a block of contacts associated to the own mechanism.
